(19) United States
(12) Patent Application Publication
(10) Pub. No.: US 2008/0289467 A1
(43) Pub. Date: Nov. 27, 2008

(54) Wet Wheel Cutter

(76) Inventors: Simon James Skillings, Staffordshire (GB); Paul Steabben Hepworth, Surrey (GB)

Correspondence Address: DICKSTEIN SHAPIRO LLP, 1825 EYE STREET NW, Washington, DC, 20006-5403, US

(21) Appl. No.: 11/632,495

(22) PCT Filed: Jul. 7, 2005
(86) PCT No.: PCT/GB05/02702

§ 371 Date: Mar. 13, 2008

(30) Foreign Application Priority Data
Jul. 14, 2004 (GB) 0415682.4

(51) Int. Cl. B23D 45/06; B23D 59/02

(52) U.S. Cl. 83/169; 83/477.2; 83/171; 83/477.1

(57) ABSTRACT

A wet wheel cutter including a table top (12) mounted upon a support body, (14) a cutter blade (20) projecting above the table top (12) and being movably mounted for movement between a first angular position and a second angular position relative to the table (top 12), the first and second angular positions being different, the table top (12) being maintained at the same orientation relative to the support body (14) when the blade (20) is at its first and second angular positions.

The present invention relates to a wet wheel cutter, in particular a wet wheel cutter suitable for cutting ceramic tiles.

A general aim of a preferred embodiment of the present invention is to provide a wet wheel cutter which has a cutter blade mounted for angular movement relative to a table top between a first angular position whereat the plane of the blade is preferably perpendicular to the table top and another angular position whereat the plane of the blade is at an angle less than 90° to the table top.

According to one aspect of the present invention there is provided a wet wheel cutter including a table top mounted upon a support body, a cutter blade projecting above the table top and being movably mounted for movement between a first angular position and a second angular position relative to the table top, the first and second angular positions being different, the table top being maintained at the same orientation relative to the support body when the blade is at its first and second angular positions.

Various aspects of the present invention are hereinafter described with reference to the accompanying drawings, in which:—

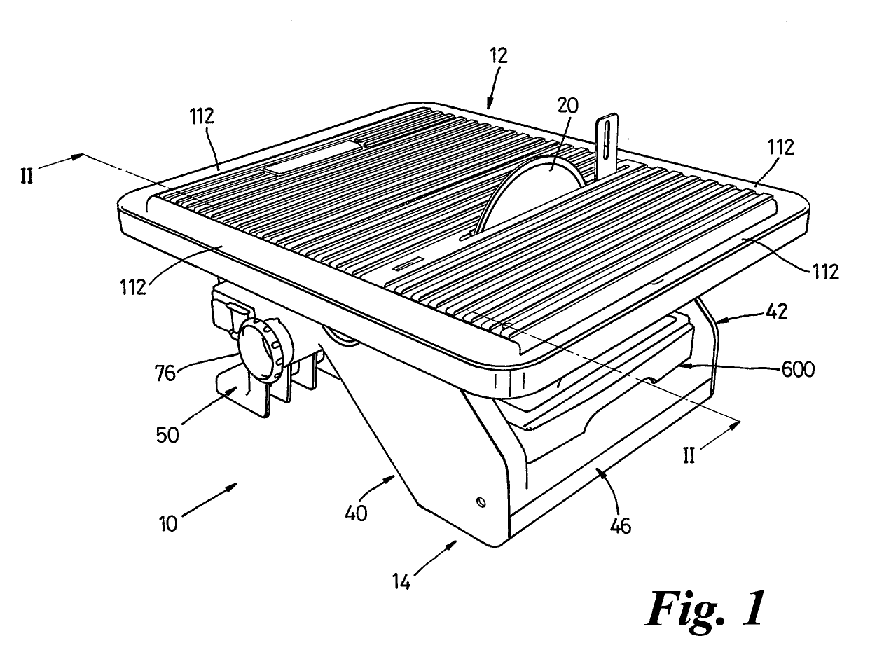

FIG. 1 is a perspective view of an embodiment according to the present invention;

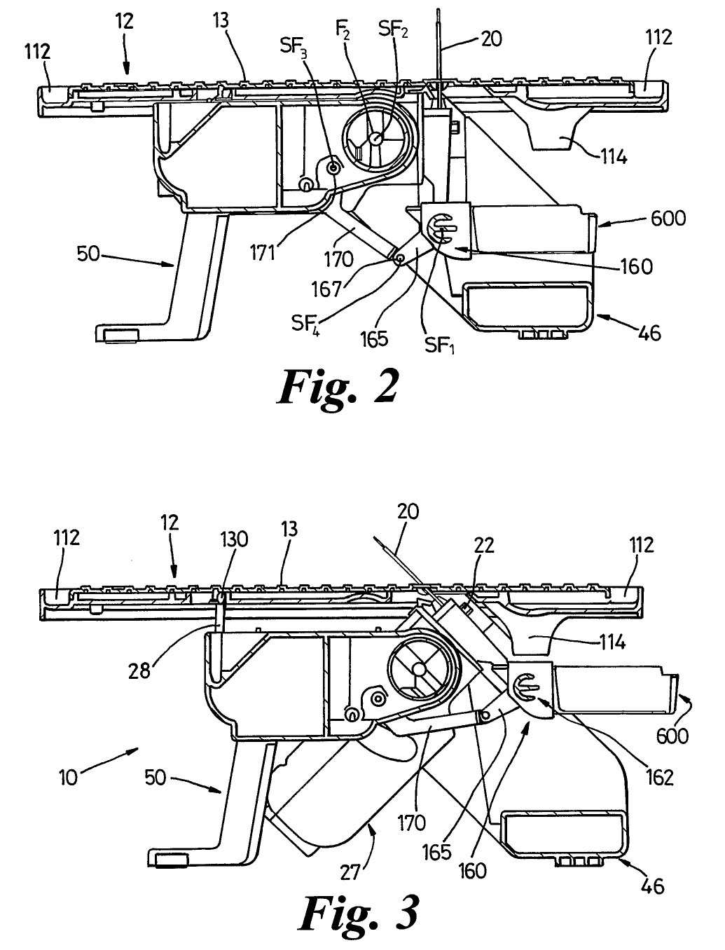

FIG. 2 is a section taken along line II-II in FIG. 1;

FIG. 3 is a similar view to FIG. 2 showing the cutter blade at a tipped position;

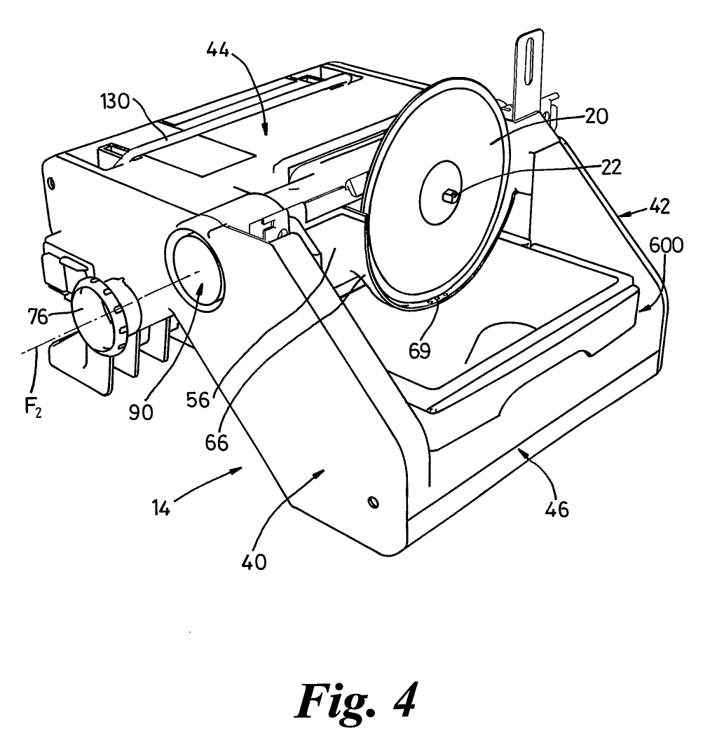

FIG. 4 is a similar view to FIG. 1 with the table top removed;

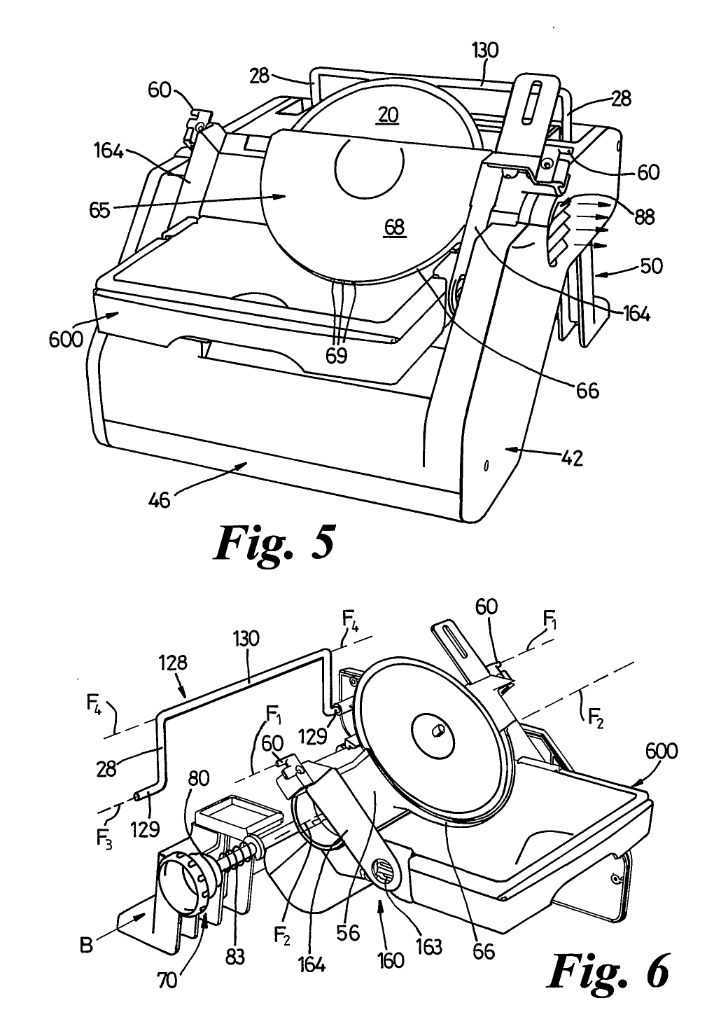

FIG. 5 is a perspective view, from a different angle, of the cutter shown in FIG. 4 and with the blade at a tipped position;

FIG. 6 is a perspective view similar to FIG. 5, taken from a different angle and with further parts removed;

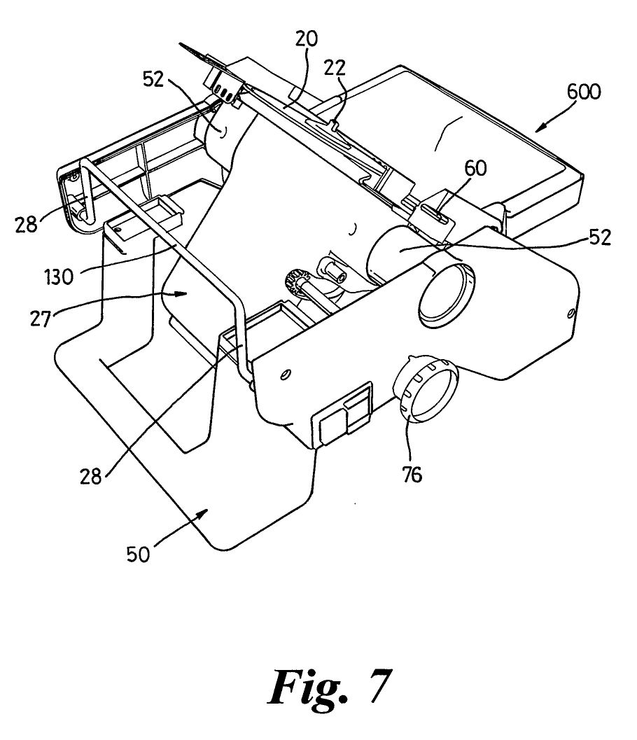

FIG. 7 is a perspective view of the cutter of FIG. 1 as viewed from above and with various parts removed and showing the blade at a tipped position;

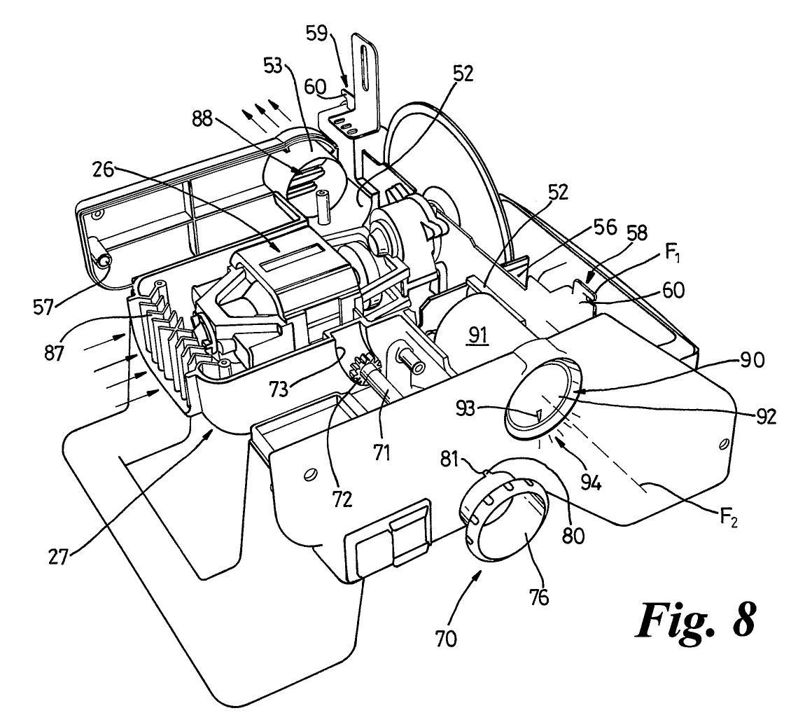

FIG. 8 is a perspective view of the cutter as shown in FIG. 7 with further parts removed and with the blade in its normal upright position;

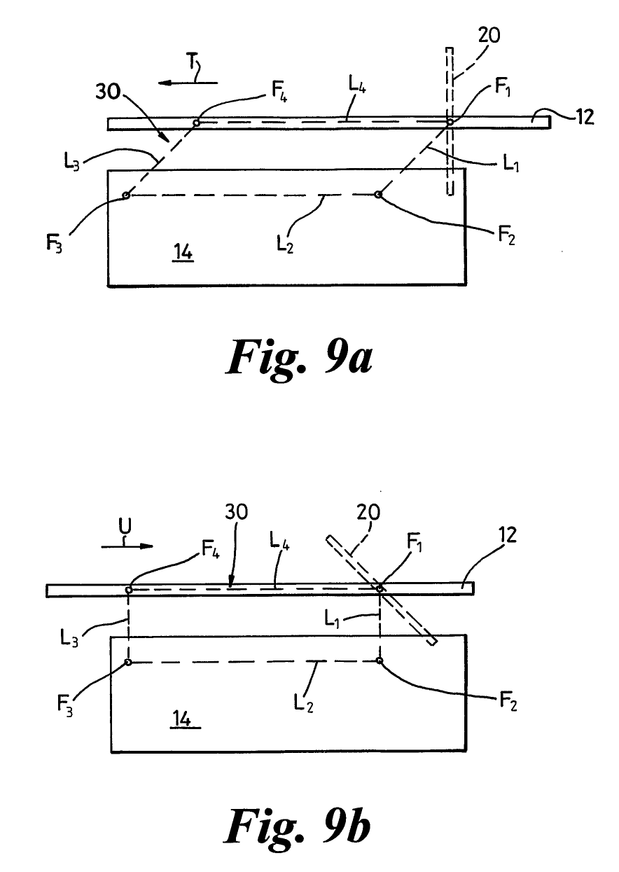

FIG. 9a, 9b illustrates, schematically, mounting of the table top upon the support body of the cutter.

The cutter 10 shown in the drawings includes a table top 12 which is supported upon a support body 14.

The cutter 10 further includes a cutter blade 20, preferably a diamond wet wheel cutter blade, which is mounted on the drive shaft 22 of an electric motor 26 housed in a casing 27.

As indicated by comparing FIGS. 2 and 3, the blade 20 is mounted so as to be movable relative to the table top 12 such that the blade 20 may be inclined, or tipped, relative to the upper surface 13 of the table top 12 between a normal upright position (FIG. 2) and a tipped position (FIG. 3).

In the normal upright position the plane of the blade 20 subtends an angle of 90° with the upper surface of the table top (i.e. it is perpendicular to the upper surface 13). In its tipped position, the plane of the blade 20 subtends an angle of less than 90° with the upper surface 13. This angle may be 45° to thereby enable a 45° mitre cut to be made in a tile being cut on the cutter. Preferably, as schematically illustrated in FIGS. 9a, 9b, in order to achieve relative movement between the blade 20 and upper surface 13 for causing adjustment of the blade 20 between its normal upright and tipped positions, the table top 12, support body 14 and motor casing 27 form respective sides of a four bar linkage 30. In FIGS. 9a, 9b the four bar linkage 30 is illustrated as having first, second, third and fourth pivot points F₁, F₂, F₃ and F₄ respectively. The four bar linkage 30 is also illustrated by broken lines as having first, second, third and fourth links or sides L₁, L₂, L₃ and L₄ respectively.

In the preferred embodiment 10 illustrated in FIGS. 1 to 8, the motor casing 27 forms the first link L₁, the support body 14 forms the second link L₂ and the table top 12 forms the fourth link L₄. As described below, the third link L₃ is formed by a link bar 28.

In FIG. 9a, the blade 20 is shown in its normal upright position. In order to tip the blade 20 to its tipped position (as seen in FIG. 3), the four bar linkage 30 is operated such that the table top 12 moves in the direction of arrow T. This causes the link L₁ to rotate about pivot point F₂ in an anti-clockwise direction and so causes the blade 20 to simultaneously tip relative to the table top 12. The blade 20 is returned to its normal position by operating the four bar linkage to move the table top 12 in the direction of arrow U.

Preferably as illustrated in FIGS. 9a, 9b, the geometry of the four bar linkage 30 is chosen such that the upper surface 13 of the table top 12 remains horizontal throughout its range of movement.

The support body 14 shown in the cutter 10 of FIGS. 1 to 8 includes a front housing part 40, a rear housing part 42, an upper central housing part 44 and a lower central housing part 46.

The upper and central housing parts 44, 46 serve to connect the front and rear housing parts 40, 42 and so provide integrity for the support body 14. Preferably the housing parts 40, 42, 44 and 46 are formed as plastics mouldings.

The lower central housing part 46 preferably defines a foot on the right hand side of the support body 14 (as seen in FIGS. 1, 2 and 3) for supporting the body 14 on a flat surface such as a bench top.

The left hand side of the support body 14 preferably includes a foot member 50 secured to the front and rear housing parts 40, 42. Preferably the foot member 50 is formed by a metal casting.

The motor casing 27, as more clearly seen in FIGS. 7 and 8, includes on each of its front and rear sides, a hollow shaft or sleeve 52 which is rotatably received on a trunnion 53 formed on a respective front and rear housing part 40, 42. Accordingly the motor casing 27 is constrained to pivot about an axis defined by co-operation between the trunnions 53 and sleeves 52; this axis defining the pivot F₂ of the four bar linkage.

The motor casing 27 has a side wall 56 located adjacent to the cutter blade 20 to provide a shield to restrain ingress of water towards the motor 26.

A pair of mounting brackets 58, 59 are provided on the casing 27 adjacent side wall 56, the brackets 58, 59 having a stub shaft 60 upon which the table 12 is mounted. The table 12 has co-operating recesses for pivotally receiving the respective stub shafts 60 in order to define the F₁ pivot of the four bar linkage.

A mounting bar 128 is provided which is of general U shape and having a pair of shaft projections 129 at its terminal ends. The shaft projections 129 are co-axial and are each pivotally received in a bore 57 formed in a respective front and rear housing 40, 42 thereby co-operate to define pivot F₃ of the four bar linkage.

The central portion 130 of the bar 128 extends in a generally rectilinear manner parallel to the shaft projections 129.

The central portion 130 is pivotally received in a recess formed on the underside of the table top 12 and co-operates therewith to define pivot F₄ of the four bar linkage.

Adjustment of the four bar linkage for moving the cutter blade 20 between its normal upright position (FIG. 2) to its fully inclined position (FIG. 3) is preferably achieved using a mechanical adjustment mechanism 70 located to the front of the cutter 10.

The adjustment mechanism 70 preferably includes a drive shaft 71 (FIGS. 7 and 8) which has a pinion gear 72 mounted thereon. The pinion gear 72 is in mesh with a rack 73 formed in the motor casing 27. Accordingly rotation of drive shaft 71 causes the motor casing 27 to be moved about pivot F₂ and thereby causes adjustment of the four bar mechanism. Rotation of the drive shaft 71 is preferably achieved manually via a handle 76 mounted on the shaft 71.

Preferably a positional lock is provided for retaining the cutter blade 20 in its normal and inclined positions.

Preferably the positional lock acts upon the drive shaft 71 in order to retain the cutter blade 20 in its normal or inclined position. In this respect, the handle 76 is preferably adopted to co-operate with the housing part 40 in order to define the positional lock.

Accordingly, as seen in FIGS. 6, 7 and 8, the handle 76 is preferably provided with at least one axially extending latch projection 80 which is received in a latch accommodating recess 81. Whilst the projection 80 is seated within recess 81, the handle 76 and hence shaft 71 is prevented from rotating in either direction.

The shaft 71 is mounted in the housing part 40 so as to be axially movable and is biased in the axial direction B by a spring 83 such that the handle 76 is biased to an axial position to maintain projection 80 within recess 81. To adjust the inclination of the cutter blade 20, the handle 76 is manually pulled in an axial direction opposite to direction B in order to move the projection 80 out of recess 81. The handle 76 is then rotated to cause rotation of shaft 71.

Preferably the gearing ratio between the pinion gear 72 and rack 73 is such that one complete revolution of shaft 71 moves the cutter blade 20 from its normal upright position to its maximum inclined position (which in the illustrated embodiment is preferably 45°). Accordingly, this enables the projection 80 and recess 81 to lock the cutter blade 20 at both its normal and fully inclined positions.

It is envisaged that the cutter blade 20 may be retained at an inclined position intermediate it's normal and fully inclined positions, say at an angle of 30° and/or 22½°. This can be conveniently achieved by providing the housing part 40 with additional recesses 81 angularly spaced about the axis of rotation of the handle 76.

A gauge assembly 90 may be provided for indicating the inclined position of the cutter blade 20. The gauge assembly 90 may conveniently be in the form of a hollow cylindrical member 91 having a closed end 92. The member 91 is seated within the front sleeve 52 of the motor casing 27 so as to rotate therewith and rotatably extends through the hollow trunnion of the front housing part 40.

The closed end 92 carries a marker 93 which moves along an angular scale 94 on the housing part 40 (it will be appreciated that the marker 93 may be provided on the housing part 40 and the angular scale 94 be provided on the closed end 92).

It is preferred that the motor 26 is positioned so as to be located inbetween the pivot points F₁, F₄ and for the links L₁, L₃ to be inclined to the right of pivot points F₂, F₃ respectively (FIG. 9a) when the cutter blade 20 is located in its normal position. With this preferred arrangement, the weight of the motor 26 and the weight of the table top 12 counterbalance one another and so reduce the load required to rotate handle 76 when adjusting the four bar linkage. This effect can be readily appreciated by considering FIG. 9a wherein it will be seen that the weight of the table top 12 tends to rotate link L₁ in a clockwise direction about pivot F₂ whereas the weight of the motor 26 tends to rotate link L₁ in an anti-clockwise direction about pivot F₂.

As more clearly seen in FIG. 8, the end of the motor casing 27 opposite to the cutter blade 20 is preferably provided with a vent opening 87 and the hollow trunnion in the rear housing part 42 also defines a vent opening 88. This enables a flow of air (as shown by the arrows in FIG. 8) to enter and exit the motor casing 27 for cooling of the motor 26. Apart from these vent openings, the motor casing 27 totally encloses the motor 26 and so prevents ingress of water.

The cutter blade 20 is preferably a diamond wet wheel cutter blade and so requires to be immersed, at its lower portion, in a bath of water.

The bath of water is preferably provided by an open topped tray 600 which in use is partially filled with water to cover the lower portion of the blade 20 by a desired amount.

Preferably the lower half of the blade 20 is housed in a cowling 65 which is preferably defined by a curved wall portion 66 formed on the side wall 56 of the motor casing 27 and a cover 68 secured to the curved wall portion 66.

Apertures 69 are provided in the lower region of the curved wall portion 66 to enable water to enter internally of the cowling 65 from the tray 600 to be picked up by the rotating blade 20. The cowling 65 provides the advantage of preventing splashing or creation of a mist caused by the rotating blade 20 and thereby reduces spillage of water.

The tray 600 is preferably removably mounted in a cradle 160 to thereby enable the tray 600 to be removed for filling and/or cleaning.

The cradle 160 is preferably movably mounted in order to ensure that the cowling 65 remains immersed in the bath of water contained in the tray 600 irrespective of whether the blade 20 is at its normal position or at one of its inclined positions.

Preferably the cradle 160 is movably mounted by means of a four bar linkage so that it maintains the tray 600 horizontally throughout the range of adjustment of the blade 20 and also maintains the required height relationship between the blade 20 and tray 600 to ensure that the blade 20 remains immersed in the bath of water in the tray 600.

The pivot points for the cradle four bar linkage which mounts cradle 160 is illustrated most clearly in FIGS. 2, 3 and 6. The cradle 160 is pivotally mounted by projections 162 on its front and rear sides respectively in recesses 163 formed in a pair of depending arms 164 extending from the side wall of the motor casing 27. The projections 162 and recesses 163 co-operate to define the first pivot point SF₁ of the cradle four bar linkage.

The pivot point F₂ of the four bar linkage which connects the motor casing 27 and table top 12 also forms the second pivot point SF₂ for the cradle four bar linkage.

A link 170 is pivotally attached to each of the front and rear housing parts by a pivotal connection 171. The pivotal connection 171 defines the third pivot point SF₃ of the cradle four bar linkage.

The front and rear sides of the cradle 160 are each provided with depending link arms 165 which are each pivotally attached to links 170 via a pivotal connection 167. Pivotal connections 167 define the fourth pivot point SF₄ of the cradle four bar linkage.

Since the pivot point F₂, SF₂ is common to both four bar linkages, and since the motor casing 27 forms a link within each four bar linkage, it will be appreciated that adjustment of the four bar linkage connecting the table top 12 and motor casing 27 will cause a simultaneous adjustment (which is always in synchronism) of the cradle four bar linkage.

The table top 12 is preferably provided with a water drainage channel 112 which preferably extends completely round the periphery of the table top 12. Preferably the channel 112 feeds into a funnel 114 located beneath the table top 12. The funnel 114 is located above the tray 600 throughout the entire range of movement of the table top 12 and serves to permit water to drain from the table top 12 via channels 112 and into the tray 600.

1. A wet wheel cutter including a table top mounted upon a support body, a cutter blade projecting above the table top and being movably mounted for movement between a first angular position and a second angular position relative to the table top, the first and second angular positions being different, the table top being maintained at the same orientation relative to the support body when the blade is at its first and second angular positions.

2. A cutter according to claim 1 wherein the table top and cutter blade are movably mounted on said support body via a four bar linkage to enable the blade to move relative to the table top between its angular positions.

3. A cutter according to claim 2 wherein the cutter blade is mounted on an electric motor, the electric motor being pivotally mounted on said support body via a first pivot point of said four bar linkage.

4. A cutter according to claim 3 wherein the four bar linkage is arranged such that the weight of the table top and motor act to counterbalance one another.

5. A cutter according to claim 3 wherein the motor is housed in a casing, the casing being pivotally mounted on the support body via a hollow tubular connection which defines a vent opening for the casing.

6. A cutter according to claim 4 wherein the motor is housed in a casing, the casing being pivotally mounted on the support body via a hollow tubular connection which defines a vent opening for the casing.

7. A cutter according to claim 1 including a water tray mounted beneath the table top into which said blade extends.

8. A cutter according to claim 5 including a water tray mounted beneath the table top into which said blade extends.

9. A cutter according to claim 8 wherein the water tray is carried by said motor casing and support body via a further four bar linkage.
